(19) United States
(12) Patent Application Publication
(10) Pub. No.: US 2022/0070409 A1
(43) Pub. Date: Mar. 3, 2022

(54) LIGHTING SYSTEM FOR VIDEO CONFERENCE PARTICIPANTS

(71) Applicant: Under Silver Lining Industries LLC, Needham, MA (US)

(72) Inventor: Jane M. O'Loughlin Walsh, Needham, MA (US)

(73) Assignee: Under Silver Lining Industries LLC, Needham, MA (US)

(21) Appl. No.: 17/399,960

(22) Filed: Aug. 11, 2021

Related U.S. Application Data
(60) Provisional application No. 63/073,014, filed on Sep. 1, 2020.
(60) Provisional application No. 63/079,079, filed on Sep. 16, 2020.
(60) Provisional application No. 63/112,760, filed on Nov. 12, 2020.
(60) Provisional application No. 63/156,664, filed on Mar. 4, 2021.

(51) Int. Cl. H04N 7/14; H04N 7/15; H04N 5/225; H04N 5/235; F21V 33/00; F21V 14/02

(52) U.S. Cl. CPC H04N 7/144; H04N 7/15; H04N 5/2256; H04N 2007/145; F21V 33/0052; F21V 14/02; H04N 5/2354

(57) ABSTRACT

A system illuminates a face of a video conference participant (user). Lighting mechanisms each include lighting elements that emanate light from the left and right of the face of the user, below the face of the user and/or above the user, each emanating light from in front of, and in a direction of, the face of the user. A brightness of the light emanating from the lighting elements may be adjustable using a control mechanism, which may be handheld with tactile or software controls. The positions of the lighting mechanisms may be moved side to side, backward and forward, and up and down relative to the user's face, and may be configured to enable the angles of the lighting mechanisms relative to the face of the user to be adjusted to further improve the properties of the light illuminating the user's face to the desired taste of the user.

### BACKGROUND

### Technical Field

This application generally relates to video conferencing, and more particularly to a lighting system for a video conference participant

### Description of Related Art

Video conferencing, both for business and personal use, has seen increased usage recently due generally to an ever-growing remote workforce and improved technology, and more acutely because of the Covid-19 pandemic.

The image presented of a video conference participant (referred to herein as a “user”) may be negatively impacted by excessively poor lighting of the participant. For example, if a window is located behind a user, the user may be ‘back lit’ such that the face of the user is cast in shadows. If a window is located beside the user, the participant may be “side lit,” which may result, for example, with half of the user's face being overexposed and the other half being cast in shadows. Furthermore, a single, poorly positioned light can create similar problems, which may be further exacerbated if the lighting is excessively bright and/or excessively dim.

Video conference applications, for example, running on a user's smartphone, laptop, tablet or desktop computer, often display to each user the user herself along with the other participants. Thus, if the image of a user is unflattering, the user may be kept aware of this throughout the video conference session, as if the user were looking in a mirror, knowing that the other participants are presented with the unflattering image throughout as well. Aside from being embarrassing, the unflattering image may have additional personal and business consequences, for example, if the video conference is part of a job interview, a business presentation, or a first date.

What may be desirable is a way to consistently provide as flattering an image as feasible of a user during video conferences.

### SUMMARY OF THE INVENTION

In an embodiment of the system described herein, a system includes: a plurality of lighting mechanisms arrangeable to provide lighting for a facial area of a video participant from a general direction of a video camera facing the video participant, each lighting mechanism including one or more lighting elements that emanate light; and a control module controllable by the video participant that controls one or more lighting properties of the lighting, wherein the control module separately controls two or more subsets of the plurality of lighting mechanisms. The plurality of lighting mechanisms may include: a first lighting mechanism arranged on a first side of the video capture device, and arranged facing the video participant; and a second lighting mechanism arranged on a second side of the video capture device opposite to the second side, and arranged facing the video participant. The plurality of lighting mechanisms may include: a third lighting mechanism arranged on an underside of the video capture device below a height of the face of the video participant, and arranged facing the video participant. The first lighting mechanism may be a member of a first subset of the two or more subsets, and the second lighting mechanism may be a member of a second subset of the two or more subsets, and the control module may control one or more lighting properties of the first lighting mechanism separately from controlling one or more lighting properties of the second lighting mechanism. The camera may be embedded in a device that is one of the following: a desktop computer, a laptop computer, a tablet computer, a smartphone or a stand-alone camera device. One or more of the plurality of lighting elements may be physically coupled to the device. At least one of the plurality of lighting mechanisms may have a component that enables the lighting mechanism to stand on a generally flat horizontal surface. At least one of the plurality of lighting mechanisms may have a component that enables the lighting mechanism to attach to a device that includes the video capture device. The control module may be part of a hand-held device. The plurality of lighting mechanisms may be configured to provide diffused lighting. The system further may include: a support mechanism that supports, and elevates a height of, the video capturing device, wherein a height of the elevation component may be adjustable. One or more of the plurality of lighting elements may be physically coupled to the support mechanism. The control module may control a height of the elevation component. The one or more lighting properties may include brightness. The one or more lighting properties include color temperature. An arrangement of at least one of the lighting mechanisms relative to a vertical axis of the at least one lighting mechanism may be adjustable. An arrangement of at least one of the lighting mechanisms relative to a horizontal axis of the at least one lighting mechanism may be adjustable.

In another embodiment of the system described herein, a method includes: providing a plurality of lighting mechanisms arrangeable to provide lighting for a facial area of a video participant from a general direction of a video camera facing the video participant, each lighting mechanism including one or more lighting elements that emanate light; receiving a first input from the video participant to adjust a lighting property of a first subset of the plurality of lighting mechanisms; in response to receiving the first input, controlling the adjustment of the lighting property of the first subset; receiving a second input from the video participant to adjust a lighting property of a second subset of the plurality of lighting mechanisms; and, in response to receiving the second input, controlling the adjustment of the lighting property of the second subset.

In another embodiment of the system described herein, a system includes: a device including a video camera; a plurality of lighting mechanisms arrangeable to provide lighting for a facial area of a video participant from a general direction of the video camera facing the video participant, each lighting mechanism including one or more lighting elements that emanate light, the plurality of lighting mechanisms including: a first lighting mechanism arranged on a left of the device and facing the facial area of the video participant, a second lighting mechanism arranged on a right side of the device and facing the facial areas of the video participant, and a third lighting mechanism arranged in front of the device, below a height of the facial areas of the video participant, and facing the facial areas of the video participant; and a control module controllable by the video participant that controls one or more lighting properties of the lighting, wherein the control module may include: a first control for controlling a lighting property of the one or more lighting elements of the first lighting mechanism, a second control for controlling a lighting property of the one or more lighting elements of the second lighting mechanism, and a third control for controlling a lighting property of the one or more lighting elements of the third lighting mechanism.

### BRIEF DESCRIPTION OF THE DRAWINGS:

Features and advantages of the system described herein will become more apparent from the following detailed description of illustrative embodiments thereof taken in conjunction with the accompanying drawings in which:

FIGS. 1-12 illustrate various embodiments of a lighting system for video conference participants, according to embodiments of the system described herein; and

FIG. 13 is a flowchart illustrating a method of a video conference participant controlling a lighting system for the video conference, according to embodiments of the system described herein.

### DETAILED DESCRIPTION OF EMBODIMENTS

Described herein is a system for illuminating a face of a video conference participant (user) and techniques for using same. The system may provide adjustable light from an area proximate to a camera that is capturing an image of the user. For example, the system may include lighting mechanisms that each include one or more lighting elements that emanate light from the left and right of the face of the user, below the face of the user and/or above the user, each emanating light from in front of, and in a direction of, the face of the user. The lighting from below the face of the user may be intended to minimize shadows that accentuate multiple (i.e., “double”) chins, jowls and other unattractive features on the underside of a face, for example, caused by excess and/or sagging skin. The lighting provided by the system described herein may be diffused using any of a variety of techniques to soften the light, including, for example, providing a shaded or relatively opaque covering over the lighting elements through which the emanating light passes through.

In some embodiments of the system described herein, a brightness (e.g., measured in lumens) of the light emanating from the lighting elements may be adjustable (e.g., dimmable) using a control mechanism, which may be handheld with tactile or software controls. The controller may include a separate control for each lighting mechanism, e.g., a right lighting mechanism, a left lighting element and a bottom lighting mechanism. Each control may enable a user to separately increase or decrease (e.g., dim) the brightness of a respective lighting mechanism, thereby enabling the user to adjust the brightness of light emanating from multiple directions to compensate for the current lighting conditions of the user's location. For example, if the user has a window located to the right of the user, the user may compensate by using the control mechanism to increase the brightness of the light emanating from the lighting mechanism on the front-left of the user, and to reduce (perhaps to zero) the brightness of the light emanating from the lighting mechanism on the front-right of the user.

In some embodiments of the system described herein, a color temperature (e.g., measured in degrees Kelvin) of the light emanating from the lighting elements may be adjusted dynamically, for example, if light-emitting diodes (LEDs) are used, e.g., using the control mechanism. In other embodiments, the color temperature of each of the lighting elements may remain static. The desired color temperature, whether static or dynamic, may be a matter of taste of the user, ranging, for example, from soft white (2700K-3000K), to bright white/cool white (3500K-4100K) to daylight (5000K-6500K).

The system may be configured to enable the positions of the lighting mechanisms to be moved side to side, backward and forward and up and down relative to the user's face, and may be configured to enable the angles of the lighting mechanisms relative to the face of the user to be adjusted to further improve the properties of the light illuminating the user's face to the desired taste of the user.

It should be appreciated that, while embodiments of the system described herein are described in relation to a user of a video conference, the invention is not so limited, as the system and techniques described herein may be used for other purposes, for example, capturing and transmitting a live video of a user for other purposes (e.g., a broadcast), recording a video (e.g., a podcast or video message), or for capturing a still image of a user. Furthermore, while embodiments of the system described herein are described in relation to capturing video or a still image using a camera of a laptop computer or smartphone, the invention is not so limited, as video or still images could be captured using other types of devices, for example, a stand-alone camera device, desktop, tablet computer, another type of computing device or another type of device. A stand-alone camera device may be a video recording device, a camera device that captures still images (e.g., an SLR camera) or a combination thereof.

The system described herein may have a variety of applications, including, but not limited to: video conferencing, providing and receiving remote education, video job interviews, video dating, creating and recording video content and recording still images.

Illustrative embodiments of the system described herein will now be described in more detail in relation to the figures.

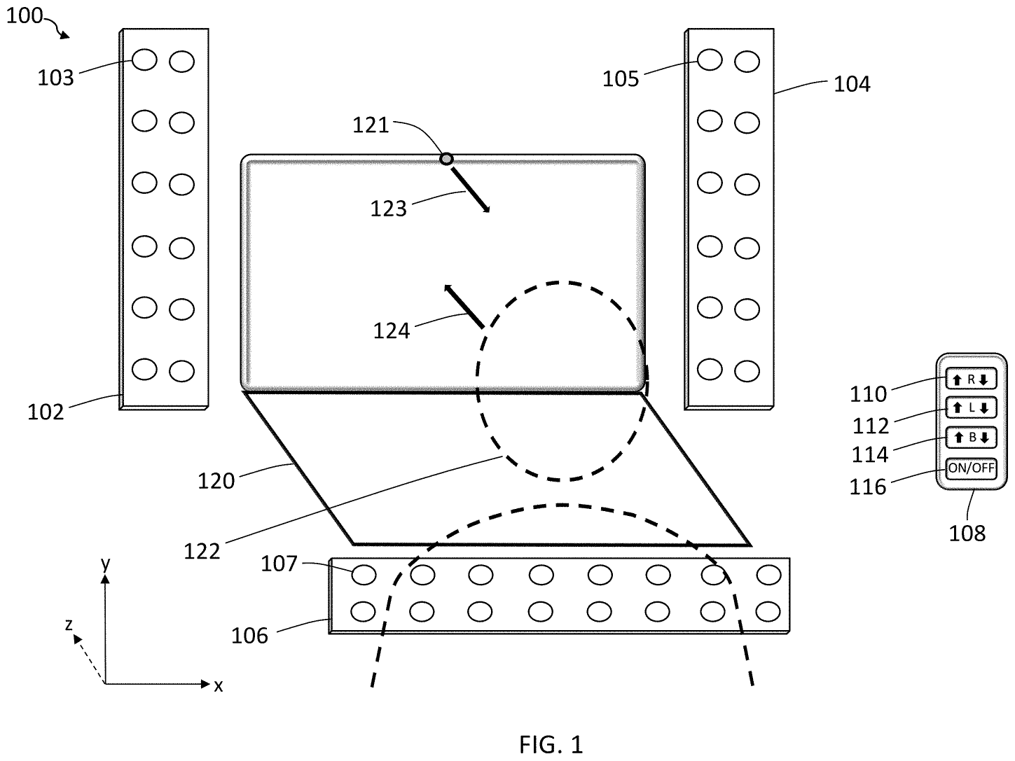

FIG. 1 is a block diagram illustrating a perspective view of an embodiment of a system 100 for illuminating a face of a user 122, according to an embodiment of the system described herein. Other embodiments of a system for illuminating a face of a user, for example, variants of the system 100, are possible, and are intended to fall within the scope of the invention.

The system 100 may include any of: lighting mechanisms 102, 104, 106, other lighting mechanisms, control mechanism 108, other components, or any suitable combination of the foregoing. Lighting mechanisms 102, 104 and 106 each may include a plurality of lighting elements 103, 105 and 107, respectively, which may be arranged in a single-dimensional (e.g., single-column) or multi-dimensional (e.g., multiple-column) array. It should be appreciated that the number of lighting elements for each lighting mechanism, and the number of rows and columns of such lighting elements, may be less or more than as shown in FIG. 1. Each lighting element may be any of a variety of types of elements such as, for example, a light-emitting diode (LED), an incandescent bulb, a fluorescent bulb, or another type of lighting element.

As illustrated in FIG. 1, the lighting elements 102, 104 and 106 may be arranged relative to the user 122 and a camera 121 capturing an image of the user 122. In FIG. 1, the camera 121 is part of a laptop computer 120, but the invention is not so limited, as the camera 121 may be part of a stand-alone camera device or be part of another device (e.g., a smartphone). The camera 121 is facing the face of the user 122 along a z dimension in FIG. 1. That is, the camera 121 is facing in the direction indicated by arrow 123, while the user 122 is looking toward the camera 121, as indicated by arrow 124. Relative to the direction 124 in which the user 122 is facing, at least one lighting mechanism, e.g., the lighting mechanism 104, may be located to the right of the camera 121, to the front-right of the user 122, facing generally in direction 123, perhaps slightly offset therefrom, angling more towards the face of the user 122, and at least one lighting mechanism, e.g., lighting mechanism 102, may be located to the left of the camera 121, to the front-left of the user 122, facing generally in direction 123, perhaps slightly offset therefrom, angling more towards the face of the user 122.

One or more lighting mechanisms, for example, the lighting mechanism 106, may be located below the camera 121 and the face of the user 122. For example, the lighting mechanism 106 may be located between the camera 121 and user 122 along the z-dimension, e.g., at a front end of the laptop computer 120. The lighting mechanism 106 may be angled up towards the face of the user 106.

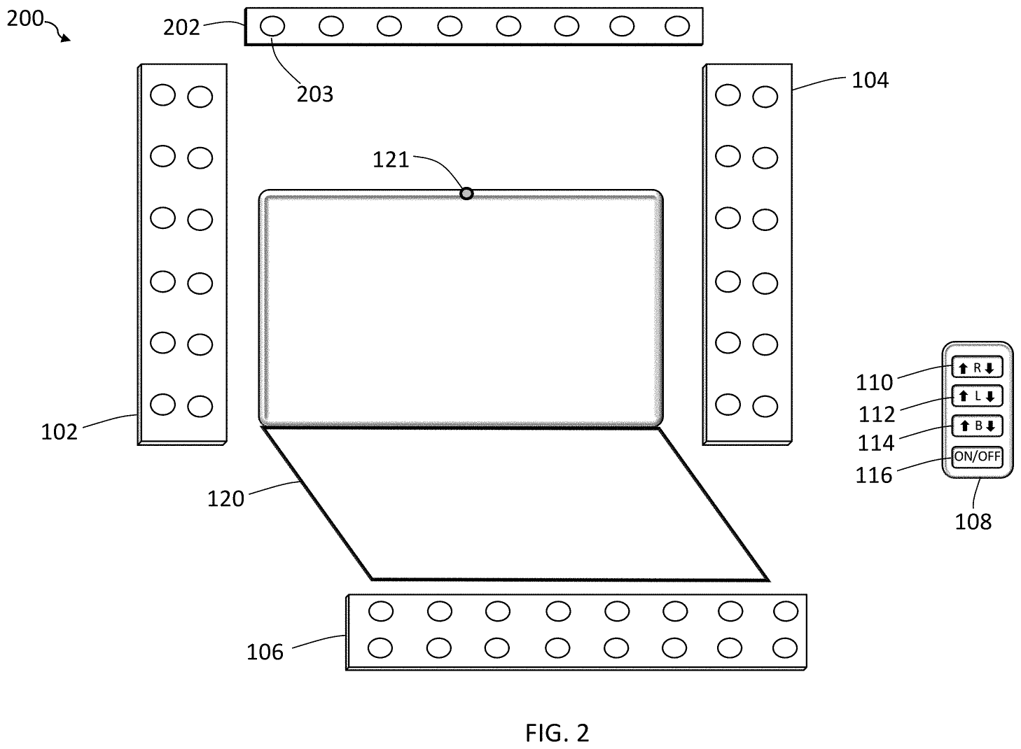

In some embodiments, one or more lighting mechanisms may be located above the camera 121, facing the user 122. For example, FIG. 2 is a block diagram illustrating a perspective view of an embodiment of a system 200 for illuminating the face of the user 122, according to an embodiment of the system described herein. The system 200 may have the same elements as the system 100, and also include lighting mechanism 202, including one or more lighting elements 203, which may be arranged in a single-dimensional (e.g., single-column) or multi-dimensional (e.g., multiple-column) array. It should be appreciated that the number of lighting elements for the lighting mechanism 202, and the number of rows and columns of lighting elements 203, may be less or more than as shown in FIG. 2. Each lighting element 203 may be any of a variety of types of elements such as, for example, a light-emitting diode (LED), an incandescent bulb, a fluorescent bulb, or another type of lighting element. The height of the lighting mechanism 202 and the lighting elements 203 may vary, and may be adjustable, for example, depending on the lighting desired and the height of the user's face.

The control mechanism 108 may include a plurality of controls for controlling the lighting mechanism 102, 104, 106 and/or 202, and the lighting elements thereof. The control mechanism 108 may be configured to control any of a variety of properties of the lighting mechanisms and lighting elements thereof, including, for example, whether the lighting elements provide any light and, if so, the brightness of the light and/or the temperature of the light. For example, the control mechanism 108 may include a master power control 116 for turning on/off all of the lighting mechanisms simultaneously, and may include dimmer controls 110, 112 and 114, which each may correspond to a separate lighting mechanism, for example, lighting mechanisms 104, 102 and 106, respectively. Each dimmer control 110, 112 and 114 may be configured to increase or decrease a brightness of the light emanating from the lighting elements of its respective lighting mechanism, e.g., to the point where a respective lighting element emanates no light (e.g., is turned off). In some embodiments, the control mechanism 108 may include a master dimmer control for all lighting mechanisms so that the brightness of the lighting elements of all of the lighting mechanisms may be controlled synchronously. In some embodiments, individual dimmer controls may be provided for each lighting element of each lighting mechanism to provide more granular control of the emanating light. Including individual controls for each lighting element may require a relatively large number of controls, which may not be desirable except for embodiments in which the controls are implemented as part of a GUI display as described in more detail elsewhere herein.

The control mechanism 108 may include controls for controlling a color temperature of the light emanating from the lighting elements, for example, individual controls for each lighting mechanism and/or a master control (not shown). The control mechanism 108 may include a microphone and logic for interpreting voice commands to control the one or more lighting mechanisms.

In some embodiments, the control mechanism 108, in its various forms described herein, also may include controls to adjust an angle and/or position of one of or more of the lighting mechanisms described herein, for example, in accordance with potential adjustments of angles and positions of lighting mechanisms described in more detail elsewhere herein. In such embodiments, the lighting mechanisms, support mechanisms described in more detail elsewhere herein and/or other components may be configured with electrical and mechanical parts that enable automated movement and communication with the control mechanism 108.

In some embodiments, the control mechanism 108 is embodied as a handheld, wireless device. For wireless embodiments of the control mechanism 108, the control mechanism may include one or more wireless interfaces and transceiver technology to enable communication with the lighting mechanisms 102, 104 and 106, which also may be configured with one or more wireless interfaces and transceiver technology for communicating with the control mechanism 108—or at least to be able to receive instructions from control mechanism. In other embodiments, one or more of the lighting mechanisms 102, 104 and 106 may be connected to the control mechanism 108 by a respective wire or cable that enables communications therebetween.

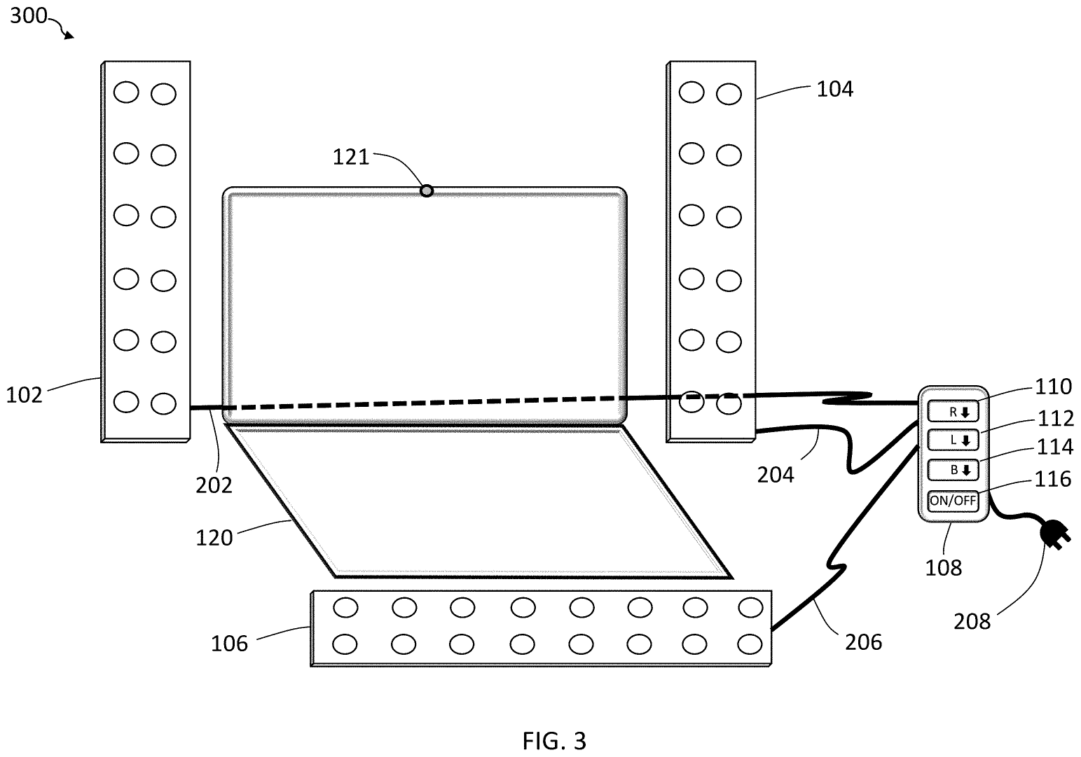

Each of the control mechanism 108 and the lighting mechanisms 102, 104 and 106 may be configured for direct current (DC) power, which may be supplied by one or more batteries or via an alternating current (AC) adapter connected to an AC power supply. FIG. 3 is a block diagram illustrating a perspective view of an embodiment of a system 300 for illuminating the face of the user 122, according to an embodiment of the system described herein, in which a control mechanism 108 and the lighting mechanisms 102, 104 and 106 are configured to be supplied power by an AC source. The control mechanism 108 may be connected to an AC adapter 208. The lighting mechanisms 102, 104 and 106 may be connected to the AC adapter 208 via the control mechanisms, through cables 202, 204 and 206, respectively, using any of a variety of power transmission and/or conversion protocols. In some embodiments, the cables 202, 204 and 206 also may serve as communication media between the control mechanism 108 and the lighting mechanisms 102, 104 and 106 according to one or more known technologies.

In some embodiments, the control mechanism 108 and/or lighting mechanisms 102, 104 and 106 may be provided power through the laptop computer 120 or another device, for example, whatever device (e.g., smartphone or stand-alone camera device) is providing the camera 121. Such power may be provided, for example, through a USB-enabled cable or another type of cable and/or technology, including wireless technology.

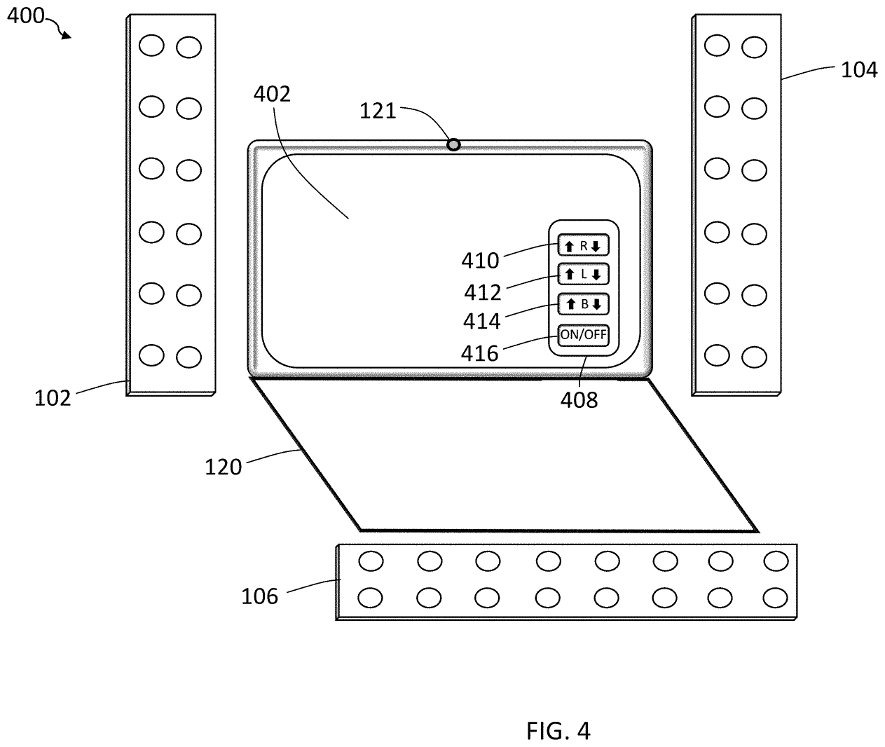

Each of the controls 110, 112, 114 and 116 of the control mechanism 108 may be a tactile control (e.g., a button, switch, knob, lever) or a software control presenting an icon on a screen of the control mechanism 108. In some embodiments, rather than being embodied as a handheld device, the control mechanism 108 or variation thereof may be presented as part of a graphical user interface (GUI) display of another device, for example, the laptop computer 106 or a smartphone, that includes the camera capturing the image of the user 122. For example, FIG. 4 is a block diagram illustrating a perspective view of an embodiment of a system 400 for illuminating a face of a user 122, according to an embodiment of the system described herein, in which a control mechanism 408 including controls 410, 412, 414 and 416 is implemented as software as part of a GUI display 402 on the laptop computer 120. It should be appreciated that any of a variety of other software configurations of a control mechanism may be implemented, and are intended to fall within the scope of the invention.

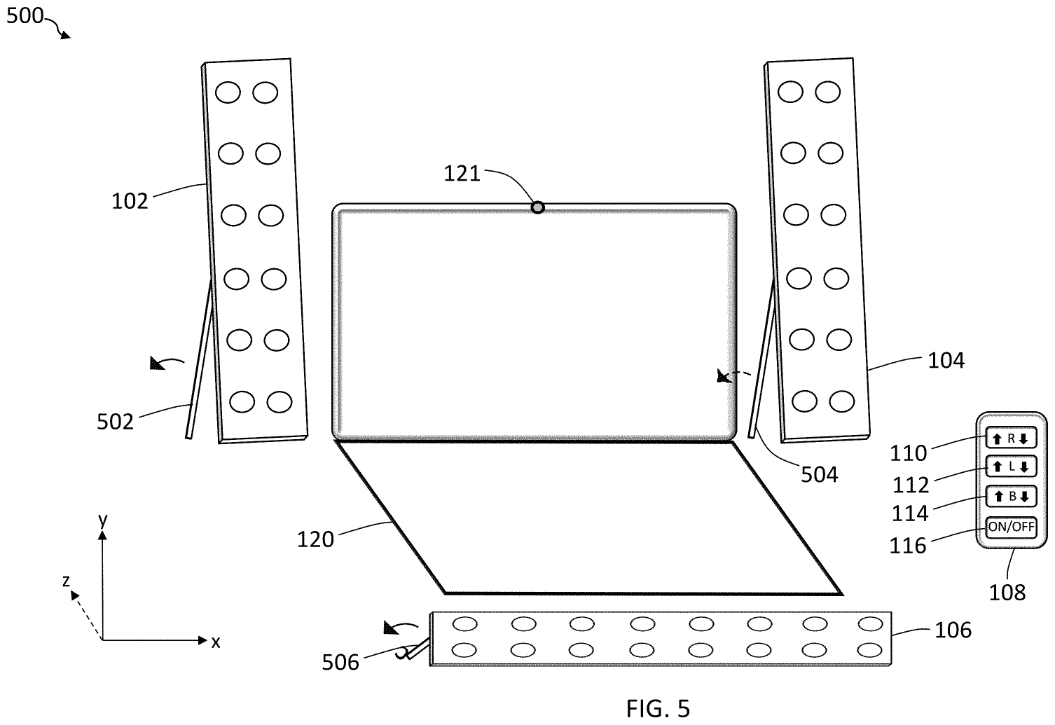

Various mechanisms and techniques may be employed to arrange light mechanisms relative the camera 121 and the user 122. For example, FIG. 5 is a block diagram illustrating a perspective view of an embodiment of a system 500 for illuminating the face of the user 122, according to an embodiment of the system described herein, in which rigid oblong members (e.g., “kickstands”) 502, 504 and 506 are provided for lighting mechanisms 102, 104 and 106, respectively, extending from a horizontal surface (e.g., desktop or tabletop) to a backside of each lighting mechanism. The kickstands 502, 504 and 506 may enable the lighting mechanisms 102, 104 and 106 to stand on a flat (at least relatively flat) horizontal surface, for example, slightly reclined back (i.e., relative to the y dimension on the y-z plane); i.e., facing slightly up. There may be one or more kickstands per lighting mechanism, for example, one on each side of a lighting mechanism and/or in the middle.

Using the kickstands, the front face of a lighting mechanism (from which the lighting elements emanate light) may be adjusted to face more upward or less upward, for example, if a backside of the lighting mechanism is configured with notches into which a top end of the kickstand may be wedged. Furthermore, the angle of the lighting mechanisms may be adjusted manually from side-to-side (i.e., relative to the x dimension on the x-z plane). For example, the lighting mechanisms 102 and 104 may be turned to face more towards or less towards the face of the user 122. In addition, a position of each of the lighting mechanisms 102, 104 and 106 on the x-z plane may be adjusted manually. That is, each of the lighting mechanisms may be moved side to side, and towards and away from, the user 122.

Each of the lighting mechanisms 102, 104 and 106 may be physically coupled to the laptop computer 120 or other device that includes the camera 121 capturing the image of the user 122, and may be physically coupled to support mechanisms supporting such devices, as described in more detail elsewhere herein.

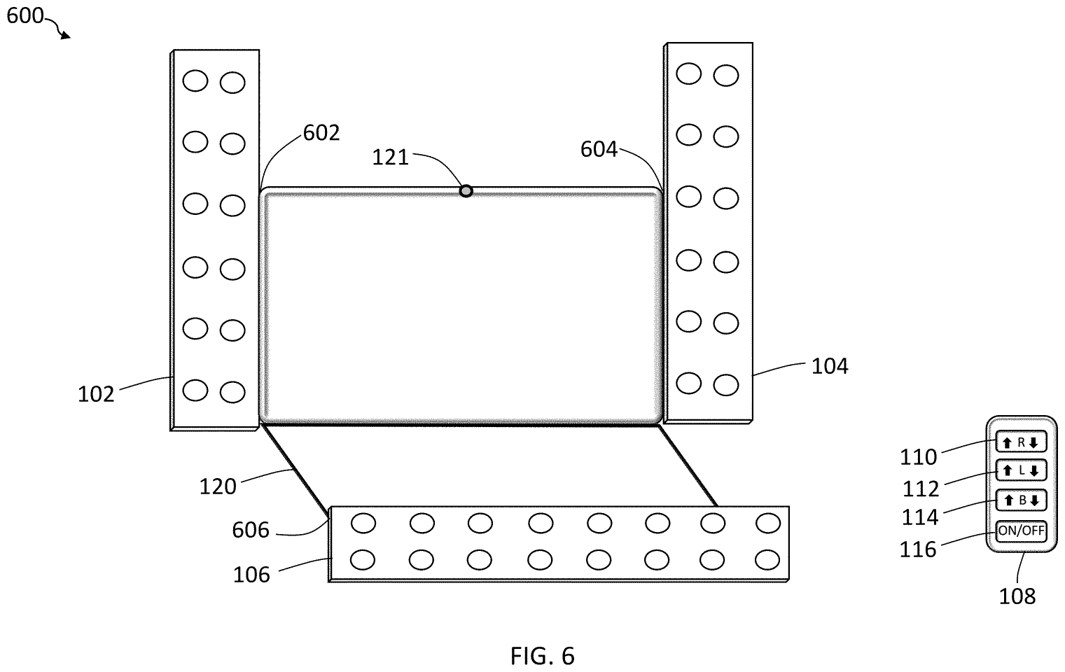

In some embodiments of the system described herein, one or more lighting mechanisms may be magnetically coupled to a support mechanism or a device that includes the camera that is capturing an image of a user. For example, FIG. 6 is a block diagram illustrating a perspective view of an embodiment of a system 600 for illuminating the face of the user 122, according to an embodiment of the system described herein, in which lighting mechanisms 102, 104 and 106 are magnetically coupled to the laptop computer 120. For example, lighting mechanisms 102, 104 and 106 may include magnetic stripping along their sides 602, 604 and 606, respectively, or may internally include magnetic material along these sides, that enables them to be coupled to the laptop computer 120 as illustrated, or to be coupled to another object, for example, a support mechanism, as described in more detail elsewhere herein.

In some embodiments, the lighting mechanisms 102 and 104 may include magnetic tabular portions that extend outward along the sides 602 and 604 that enable the lighting mechanisms 102 and 104 to be magnetized to a backside of the laptop computer 120 or another device. Similarly, the lighting mechanism 106 may include a magnetic tabular portion that extends outward along the side 606 that enable the lighting mechanism 106 to be magnetized to an underside of the laptop computer 120 or another device.

It should be appreciated that the height, width, depth and weight of the lighting mechanisms 102, 104 and 106 may vary in any of the embodiments described herein. For example, the height and width of the lighting mechanisms 102, 104 and 106 relative to dimensions of the laptop computer may be less, e.g., in particular for the embodiments of the system 600 in which the lighting mechanisms 102, 104 and 106 are magnetically attached to the laptop computer 120. For example, in any of the embodiments described herein, the height of the lighting mechanisms 102, 104 may be configured to be the same or less than the height of the screen portion of the laptop 120, and the width of the lighting mechanism 106 may be configured to be the same or less than the width of the keyboard portion of the laptop 120. Smaller dimensions and less weight of the lighting mechanism may be desirable for portability of the lighting mechanisms, alone or in combination with the laptop computer 120 (or other device described herein including the camera capturing the image of the user) or other components of a lighting system as described herein, e.g., the control mechanism 108 and/or support mechanism described elsewhere herein. For example, physical properties of the lighting mechanisms, control mechanism, support mechanism and other components according to embodiments of the system described herein may be configured to enable transport via a case or a bag, e.g., along with a device including a camera (e.g., a laptop computer); that can be carried by hand or over a shoulder.

In some embodiments of the system described herein, for example, as an alternative to using magnetization, spring-loaded clips may be used to clip any of the lighting mechanisms 102, 104 and 106 to sides or front of the laptop computer 120 or other device including the camera. Further, bungee-like mechanisms or other known mechanisms may be used to secure lighting mechanisms 102, 104 and 106 to the laptop computer 120 or another device including the camera. It should be appreciated that the various coupling mechanisms described herein for connecting lighting mechanisms 102, 104 and 106 to the laptop computer 120 or other device including the camera also may be used to connected lighting mechanism 403 to the laptop computer 120 or other device in a same or similar manner.

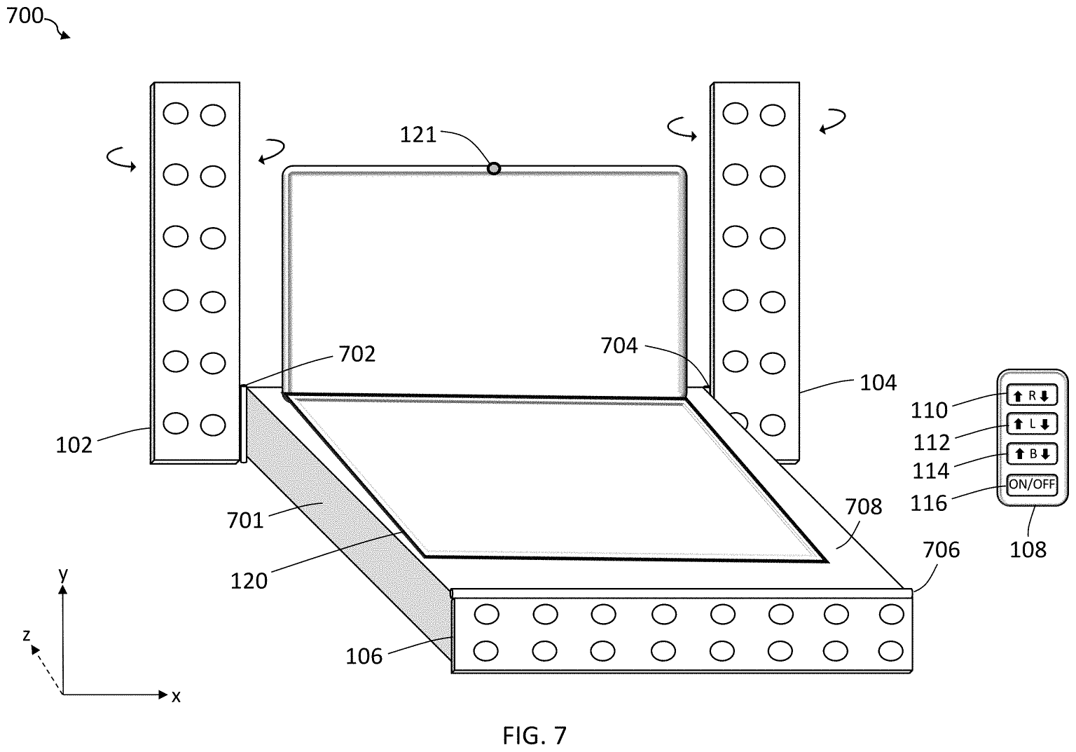

In some embodiments, a support mechanism may be provided for supporting a device including a camera (e.g., a laptop, smartphone, tablet or stand-alone camera device) that is capturing an image of a user. For example, FIG. 7 is a block diagram illustrating a perspective view of an embodiment of a system 700 for illuminating the face of the user 122, according to an embodiment of the system described herein, in which a support mechanism 701 is provided. The support mechanism 701 may be a support platform that elevates a height of the camera 121, e.g., by elevating a height of the laptop computer 120, which may be desirable to provide a more downward (i.e., less upward) angle from the camera 121 to the face of the user 122. The support mechanism 701 may have at least five sides forming a rigid rectangular prism or another suitable shape, and may be made of one or more materials sufficient to support a weight of potential devices (e.g., laptop computer, desktop computer, smartphone, tablet, stand-alone camera device) that may include the camera 121.

In some embodiments, the system 700 includes hinges 702, 704 and 706 coupling the lighting mechanisms 102, 104 and 106 to the support mechanism 701. For example, the hinges 702, 704 and 706 may be mechanically coupled (e.g., by screws, adhesive or another fastening mechanism) to both the lighting mechanisms 102, 104 and 106 and the support mechanism 701, or may be mechanically coupled to the support mechanism 701 and magnetically coupled to the lighting mechanisms 102, 104 and 106, or vice versa. The hinges 702 and 704 enable the lighting mechanisms 102 and 104, respectively, to be rotated about a longitudinal axis of the hinges 702 and 704, respectively, i.e., rotated relative to the y-dimension, which enables the angles of lighting mechanisms 102 and 104 relative to the face of the user 122 (i.e., angles relative to the x dimension on the x-z plane) to be adjusted by the user 122.

The hinge 706 may enable the lighting mechanism 106 to be rotated about a longitudinal axis of the hinge 706 i.e., rotated relative to the x-dimension, which enables the angle of the lighting mechanisms 106 relative to the face of the user 122 (i.e., relative to the y dimension on the y-z plane) to be adjusted by the user 122.

In some embodiments, the lighting mechanism 106 may be attached to a front panel of a drawer that slides out from the support mechanism 701, which enables the lighting mechanism 106 to be moved closer to the user. In such embodiments, a top edge of the lighting mechanism may be attached to the front panel of the drawer by a hinge (e.g., like the hinge 706) that enables the lighting mechanism 106 to be rotated about a longitudinal axis of the hinge i.e., rotated relative to the x-dimension, which enables the angle of the lighting mechanisms 106 relative to the face of the user 122 (i.e., relative to the y dimension on the y-z plane) to be adjusted by the user 122.

Other mechanisms may be used to couple the lighting mechanisms 102, 104 and 106 to the support mechanism 701, including magnetic elements, spring-loaded clips or other mechanisms.

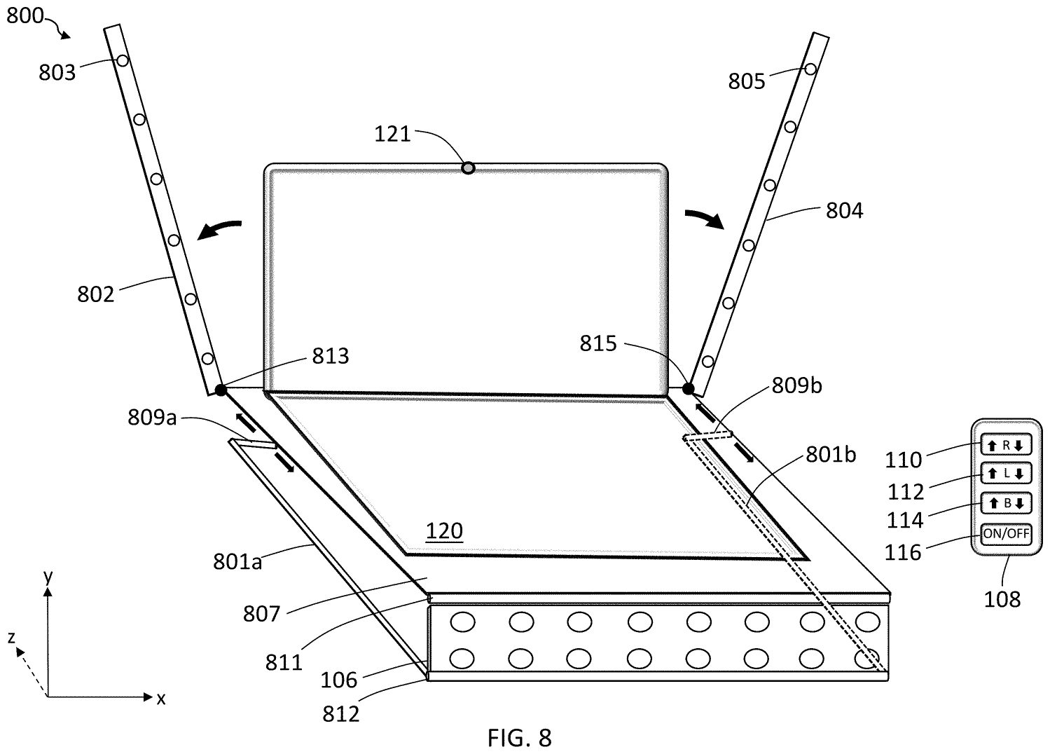

FIG. 8 is a block diagram illustrating a perspective view of another embodiment of a system 800 for illuminating the face of the user 122, according to an embodiment of the system described herein. In FIG. 8, another support mechanism may be provided in place of the support mechanism 701. Such a support mechanism may include: a planar shelf 807, base support members 801a,b, kickstands 809a,b, hinge 811 coupling the planar shelf 807 to the lighting mechanism 106, and hinge 812 coupling the the lighting mechanism 106 to the base members 801,b. The planar shelf 807 may include notches long its sides where contact is made by kickstands 809a,b such that each of kickstands 809a,b may be wedged in one of such notches to adjust the height and angle (relative to the z-dimension on the y-z plane) of the planar shelf 807.

The hinges 811 and 812 also may enable the height and angle of the planar shelf 807 to be adjusted, in combination with adjusting an angle of the of the lighting mechanisms 106 relative to the face of the user 122; i.e., relative to the y dimension on the y-z plane. In some embodiments of the system 800, instead of having the hinges 811 and 812 coupled to the lighting mechanisms 106, the support mechanism includes a rectangular planar member connected by the hinges 811 and 812 that enable adjustment of the height and angle of the planar shelf 807.

In some embodiments, the system 800 includes hinges 813 and 815 coupling the planar shelf 807 to the lighting mechanisms 802 and 804. The hinges 813 and 815 may be generally cylindrical, having an axis along the z dimension enabling an angle of each of the lighting mechanisms 802 and 804 relative to the y dimension on the x-y plane to be adjusted. In some embodiments, the hinges 813 and 815 may be replaced by ball joints that enable an angle of each of the lighting mechanisms 802 and 804 relative to the y dimension on the y-z plane to be adjusted in addition to enabling an angle relative to the y dimension on the x-y plane to be adjusted.

Lighting mechanisms 802 and 804 may be similar to the lighting mechanisms 102 and 104, and may include a plurality of lighting elements 803 and 805, respectively. In some embodiments the lighting mechanisms 802 and 804 may be smaller and lighter than lighting mechanisms 102 and 104, and may include fewer lighting elements and smaller lighting elements. For example, the lighting mechanisms 802 and 804 may be light wands. The lighter weight of the lighting mechanisms 802 and 804 may put less of a load on the hinges 813 and 815 (or ball joints in place thereof) to support the lighting mechanisms and adjust their angles.

The planar shelf 807 may include a top layer of rubberized material or tacky material to reduce movement of the laptop computer 120 or whatever other device is supported by the support mechanism.

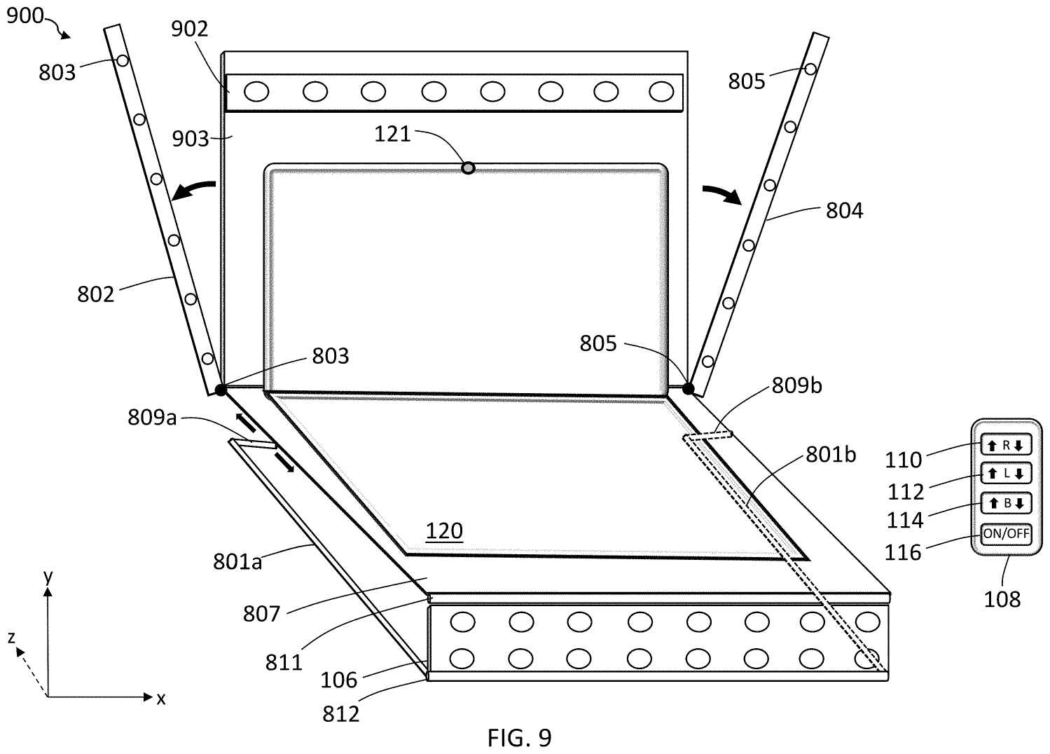

FIG. 9 is a block diagram illustrating a perspective view of another embodiment of a system 900 for illuminating the face of the user 122, according to an embodiment of the system described herein. The system 900 may have the same elements as the system 800, and also include back support 903, which may be coupled to the planar shelf 807 by a hinge (not shown) having an axis in the x dimension. The back support 903 may be used to provide vertical support for whatever device (e.g., the laptop computer 120) includes the camera 121, and may be used to adjust an angle of the camera relative to the y dimension on the y-z plane. The back support 903 also may include, or have coupled thereto, lighting mechanism 902, which may be the same as or similar to the lighting mechanism 202. The back support 903 may be used to adjust an angle of the lighting mechanism 902 relative to the y dimension on the y-z plane.

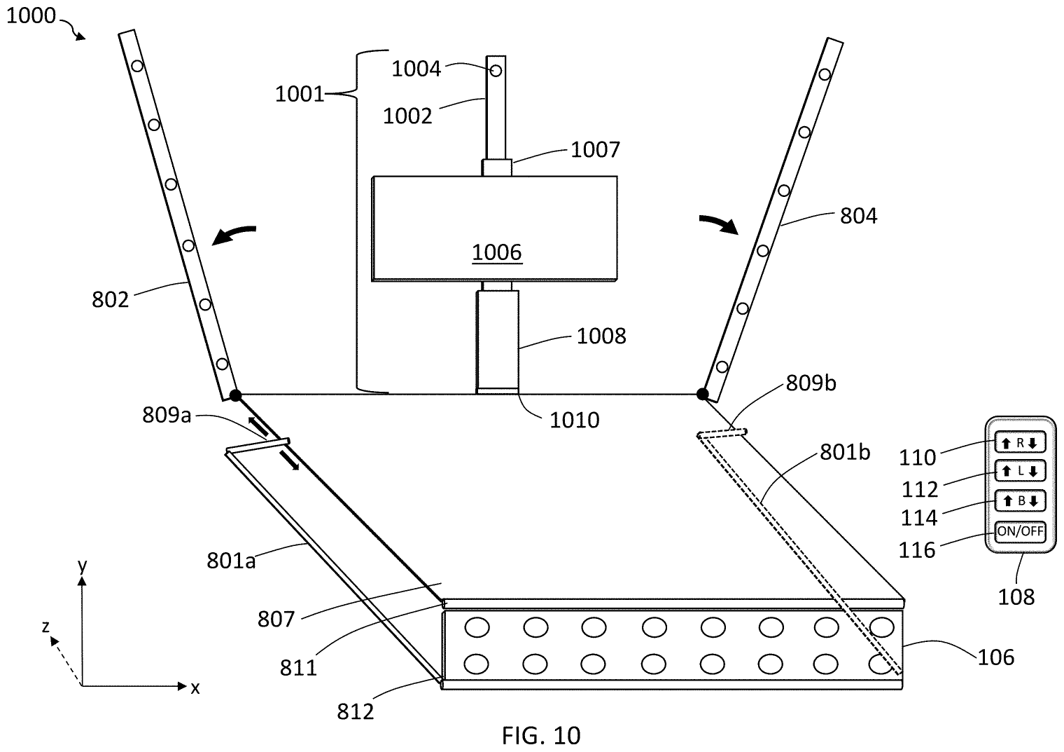

FIG. 10 is a block diagram illustrating a perspective view of another embodiment of a system 1000 for illuminating the face of the user 122, according to an embodiment of the system described herein. The system 1000 may have the same elements as the system 800, and also include a telescoping back support mechanism 1001. The mechanism 1001 may include a base portion 1008, middle portion 1007 and top portion 1004.

The top portion 1002 may include one or more lighting elements 1004 configured to face the user 122, which may be any of the types of lighting elements described herein, and may be controlled as other light elements described herein may be controlled. The middle portion 1007 may include a device holder 1007, which may be configured to hold a device (e.g., smartphone, camera) that includes a camera, and may be configured to attach to such a device (e.g., to have a device mounted thereon) using any of a variety of suitable means (not shown).

The base portion 1008 may be coupled to the planar shelf 807 by any of a variety of suitable means. In some embodiments, base portion 1008 may be coupled to the planar shelf 807 by a hinge 1008 that may enable an adjustment of an angle of the mechanism 1001, including the lighting element 1004, device holder 1006 and camera thereof relative to they dimension on the y-z plane.

It should be appreciated that, for any of the hinges described herein, the hinges may be configured to have enough resistance to maintain the hinged elements in place once adjusted or may include a means for locking the hinged elements in place.

Other support mechanisms, for example, variations of the support mechanism 701 and the support mechanism described in relation to FIG. 8 may be used. For example, a crank (e.g., motorized crank), or hinged cross-bars may be used to raise or lower the height of a planar shelf on the top side of the support and thus the height of the camera. For the cross-bar embodiments, a bottom edge of a top of the planar shelf may include notches, and the height of the platform may be adjusted by wedging the top ends of the cross-bar members into different notches.

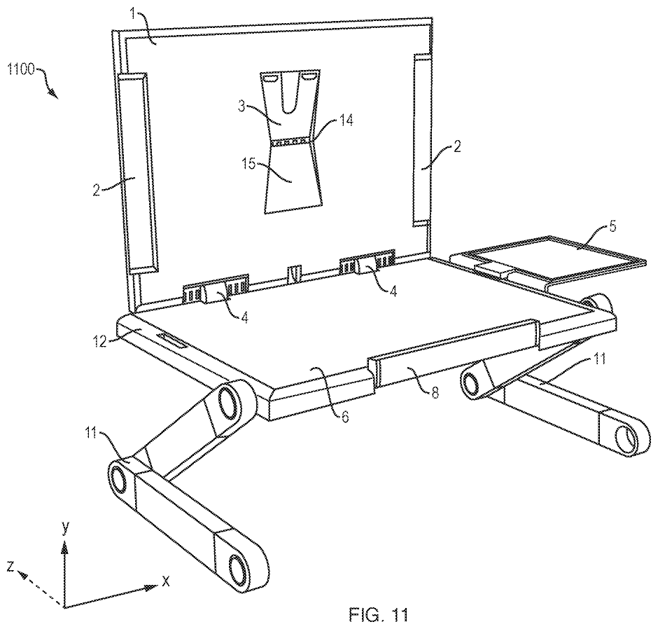

FIG. 11 is a block diagram illustrating a perspective view of another embodiment of a system 1100 for illuminating the face of the user 122, according to an embodiment of the system described herein. The system 1100 may include any of: a lid 1; a device cradle 3; side lighting mechanisms 2, hinges 4; a base 12; an anti-skid mat 6 on the top surface of the base 12; a front lighting mechanism 8, a side tray 5; and hinged legs 11.

The system 1100 may be configured to be relatively compact and portable, for example, like a laptop computer. The hinges 4 may enable the lid to close onto the base 12 like a clamshell. The side tray 5 may be configured to detach or to fold under the base 12, which may have a recessed region underneath, and on the side of, the base 12 (not shown) configured to receive the side tray 5 when folded under the base 12. The hinged legs 11 may be configured to fold into place laterally along the sides of the base 12, or to be detached.

The base 12 may be considered a load platform and together with the legs 11 may form a support mechanism of the system 1100 on which a device including a camera and/or another device or object may be placed. The side tray 5 may be configured to serve as a platform for any of a variety of accessory devices, for example, a mouse. The device cradle 3 may be attached to the lid 1 by a hinge 14 that enables the device cradle 3 to be folded into a recess 15 of the lid 1 and to be extended from the recess 15 to hold a device, for example, a smartphone or camera device. The hinge 14 may allow a range of motion of the device cradle 3 of up to a 180 degrees. In FIG. 11, an underside of the device cradle 3 is shown as it is extended about 180 degrees upwards from a position within the recess 15.

Each of the side lighting mechanisms 2 (e.g., lighting panels) and the front lighting mechanism 8 (e.g., lighting panel) may include a plurality of lighting elements as described in more detail elsewhere herein, and may include a covering that diffuses the light emanating from the lighting elements. Each side lighting mechanism 2 may be configured to extend up to a certain distance (e.g., a few inches) out from a side of the lid 2, and may be configured to rotate, for example, relative to a longitudinal axis of a hinge (not shown), or the like, affixed along a side of the lid 2 so an angle of the light emanating from the lighting mechanisms 2 relative to a face of a user can be adjusted. The side lighting mechanisms 2 are shown in a non-extended and non-rotated position in FIG. 11.

The front lighting mechanism 8 may be configured to extend up to a certain distance (e.g., a few inches) out from a front of the base 12 and/or to extend up to a certain distance (e.g., a few inches) upward from the base 12. The front lighting mechanism 8 may be configured to rotate, for example, relative to a longitudinal axis of a hinge (not shown), or the like, affixed along a front side of the base 12, so an angle of the light emanating from the lighting mechanism 8 relative to a face of a user can be adjusted. In FIG. 11, the side lighting mechanism 8 is shown extended slightly upward above the base 12, but not extended frontward from the base 12 and not rotated.

A case for holding the system 1100 may be provided along with the system 1100, and the case and system 1100 may be configured such that the system 1100 may fit efficiently (space-wise) within the case, for example, when the various components of the system 1100 are arranged in compact positions, e.g., as described in more detail elsewhere herein.

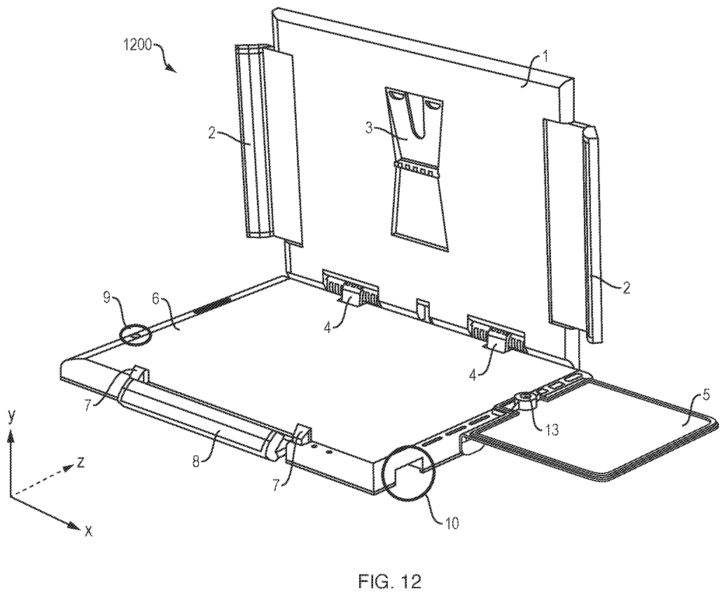

FIG. 12 is a block diagram illustrating a perspective view of another embodiment of a system 1200 for illuminating the face of the user 122, according to an embodiment of the system described herein. The system 1200 may be a variation of the system 1100, and may include many of the same elements of the system 1100, which are labeled using the same numbers. In addition, the system 1200 may include bumpers 7, and accessory mounts 9 and 13. Each of the accessory mounts 9 and 13 may be, for example, a UNC ¼-20 nut or another size and/or type of nut, which may be embedded into the base 12 or side tray 5, respectively. Each of accessory mounts 9 and 13 may be configured to mount an accessory, e.g., microphone, a camera device, smartphone or other personal computer device. For example, an accessory may be configured (e.g., diameter and threading) to receive a screw that is configured (e.g., diameter and threading) to screw into the accessory mount 9 or 13. Alternatively, an accessory may be connected (e.g., by hinge, screw or other mechanism) to a pole (e.g., a telescoping pole) configured with, or to receive, a screw configured to screw into the accessory mount 9. The system 1200 may include more or less than the two accessory mounts shown.

In FIG. 12, each of the side lighting mechanisms 2 is shown slightly extended to the side and angled towards a face of the user 122, and the front lighting mechanism 8 is angled towards a face of the user 122.

The system 1200 also may include leg sockets, including a leg socket 10, for receiving legs, for example, the legs 11 of the system 1100.

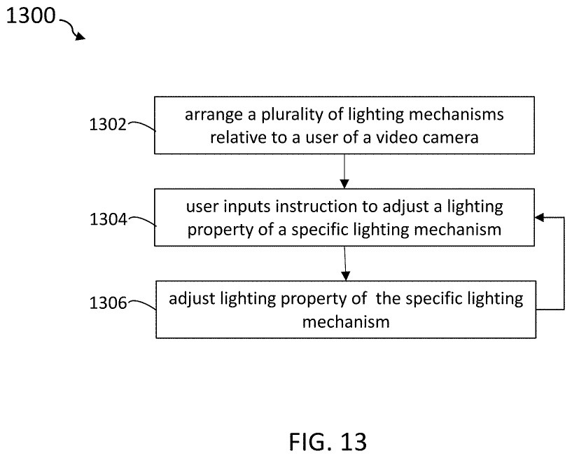

FIG. 13 is a flowchart illustrating a method 1300 of a video conference participant controlling a lighting system for the video conference, according to embodiments of the system described herein. Other embodiments of a method of a video conference participant controlling a lighting system for the video conference are possible, for example, variations of the method 1300, are possible, and are intended to fall within the scope of the invention.

In a step 1302, a plurality of lighting mechanisms may be arranged relative to a user (e.g., the user 122) of a video camera (e.g., the camera 121), for example, according to any of the embodiments described herein in relation to FIGS. 1-12.

In as step 1304, a user may input an instruction to adjust a lighting property of a specific lighting mechanism. For example, a user may press control 112 of the control mechanism 108 to increase a brightness of the light emanating from lighting elements of the lighting mechanism 102 or another control (not shown) of the control mechanism 108 to change a color temperature of the light emanating from lighting elements of the lighting element 106.

In response to the user input, the lighting property may be adjusted according to the instruction in a step 1306. For example, the control mechanism 108 may send a signal specifying the instruction wirelessly or through a wire/cable connection to the specified lighting mechanism, which may include logic (e.g., hardware and/or software) and other electronics and/or mechanical components configured to realize the received instruction. The logic and other components of the specified lighting mechanism may implement the instruction.

After or during the performance of the step 1306, the user may input another instruction in the step 1304 for adjusting a lighting property. The other instruction may be for a different lighting property and/or a different lighting mechanism than the previously received instruction, and may trigger performance of the step 1306 for the specified lighting property of the specified lighting mechanism. The steps 1304 and 1306 may be repeated each time a user inputs an instruction.

Concurrently or serially to the performance of the steps 1304 and 1306, the step 1302 may be performed, for example, in response to the user re-arranging one or more or the lighting mechanisms, for example, changing a position in the x-y plane of one or more of the lighting mechanisms as described above, or changing the angle of any of the lighting mechanisms in the x-z plane, x-y plane or y-z plane as described above.

Various embodiments of the system described herein may be combined with each other in appropriate combinations. Additionally, in some instances, the order of steps in the flowcharts, flow diagrams and/or described flow processing may be modified, where appropriate. It should be appreciated that any of the methods described herein, including methods 1300, or parts thereof, may be implemented using one or more of the systems and/or data structures described in relation to FIGS. 1-12 or components thereof. Further, various aspects of the system described herein (e.g., control mechanisms 108, 408) may be implemented using software, firmware, hardware, any suitable combination thereof and/or other computer-implemented modules or devices having the described features and performing the described functions. Logic that when executed performs methods described herein, steps thereof or portions of such methods or steps, may be implemented as software, firmware, hardware, or any suitable combination thereof.

Software implementations of embodiments of the system described herein may include executable code that is stored on one or more computer-readable media and executed by one or more processors. Each of the computer-readable media may be non-transitory and include a computer hard drive, ROM, RAM, flash memory, portable computer storage media such as a CD-ROM, a DVD-ROM, a flash drive, an SD card and/or other drive with, for example, a universal serial bus (USB) interface, and/or any other appropriate tangible or non-transitory computer-readable medium or computer memory on which executable code may be stored and executed by a processor. Embodiments of the system described herein may be used in connection with any appropriate operating system.

As used herein, an element or operation recited in the singular and preceded with the word “a” or “an” should be understood as not excluding plural elements or operations, unless such exclusion is explicitly recited. References to “one” embodiment or implementation of the present disclosure are not intended to be interpreted as excluding the existence of additional embodiments that also incorporate the recited features. Furthermore, a description or recitation in the general form of “at least one of [a], [b] or [c],” or equivalent thereof, should be generally construed to include [a] alone, [b] alone, [c] alone, or any combination of [a], [b] and [c]. In addition, use of a an ordinal term, e.g., “first,” “second” or the like, to qualify a term for an item having multiple instances of the same name does not necessarily indicate a priority, precedence or temporal order between the instances unless otherwise indicated, but rather such ordinal terms may be used merely to distinguish between the separate instances.

Other embodiments of the system described herein will be apparent to those skilled in the art from a consideration of the specification or practice of the system described herein disclosed herein. It is intended that the specification and examples be considered as exemplary only, with the true scope and spirit of the invention being indicated by the following claims.

What is claimed is:

1. A system comprising:
a plurality of lighting mechanisms arrangeable to provide lighting for a facial area of a video participant from a general direction of a video camera facing the video participant, each lighting mechanism including one or more lighting elements that emanate light; and
a control module controllable by the video participant that controls one or more lighting properties of the lighting, wherein the control module separately controls two or more subsets of the plurality of lighting mechanisms.

2. The system of claim 1, wherein the plurality of lighting mechanisms includes:
a first lighting mechanism arranged on a first side of the video capture device, and arranged facing the video participant; and
a second lighting mechanism arranged on a second side of the video capture device opposite to the second side, and arranged facing the video participant.

3. The system of claim 2, wherein the plurality of lighting mechanisms includes:
a third lighting mechanism arranged on an underside of the video capture device below a height of the face of the video participant, and arranged facing the video participant.

4. The system of claim 2, wherein the first lighting mechanism is a member of a first subset of the two or more subsets, and the second lighting mechanism is a member of a second subset of the two or more subsets, and
wherein the control module controls one or more lighting properties of the first lighting mechanism separately from controlling one or more lighting properties of the second lighting mechanism.

5. The system of claim 1, wherein the camera is embedded in a device that is one of the following: a desktop computer, a laptop computer, a tablet computer, a smartphone or a stand-alone camera device.

6. The system of claim 5, wherein one or more of the plurality of lighting elements are physically coupled to the device.

7. The system of claim 1, wherein at least one of the plurality of lighting mechanisms has a component that enables the lighting mechanism to stand on a generally flat horizontal surface.

8. The system of claim 1, wherein at least one of the plurality of lighting mechanisms has a component that enables the lighting mechanism to attach to a device that includes the video capture device.

9. The system of claim 1, wherein the control module is part of a hand-held device.

10. The system of claim 1, wherein the plurality of lighting mechanisms are configured to provide diffused lighting.

11. The system of claim 1, further comprising:
a support mechanism that supports, and elevates a height of, the video capturing device, wherein a height of the elevation component is adjustable.

13. The system of claim 11, wherein one or more of the plurality of lighting elements are physically coupled to the support mechanism.

14. The system of claim 11, wherein the control module controls a height of the elevation component.

15. The system of claim 1, wherein the one or more lighting properties include brightness.

16. The system of claim 1, wherein the one or more lighting properties include color temperature.

17. The system of claim 1, wherein an arrangement of at least one of the lighting mechanisms relative to a vertical axis of the at least one lighting mechanism is adjustable.

18. The system of claim 1, wherein an arrangement of at least one of the lighting mechanisms relative to a horizontal axis of the at least one lighting mechanism is adjustable.

19. A method comprising:
providing a plurality of lighting mechanisms arrangeable to provide lighting for a facial area of a video participant from a general direction of a video camera facing the video participant, each lighting mechanism including one or more lighting elements that emanate light;
receiving a first input from the video participant to adjust a lighting property of a first subset of the plurality of lighting mechanisms;
in response to receiving the first input, controlling the adjustment of the lighting property of the first subset;
receiving a second input from the video participant to adjust a lighting property of a second subset of the plurality of lighting mechanisms; and
in response to receiving the second input, controlling the adjustment of the lighting property of the second subset.

20. A system comprising:
a device including a video camera;
a plurality of lighting mechanisms arrangeable to provide lighting for a facial area of a video participant from a general direction of the video camera facing the video participant, each lighting mechanism including one or more lighting elements that emanate light, the plurality of lighting mechanisms including:
a first lighting mechanism arranged on a left of the device and facing the facial area of the video participant,
a second lighting mechanism arranged on a right side of the device and facing the facial areas of the video participant, and
a third lighting mechanism arranged in front of the device, below a height of the facial areas of the video participant, and facing the facial areas of the video participant; and
a control module controllable by the video participant that controls one or more lighting properties of the lighting, wherein the control module includes:
a first control for controlling a lighting property of the one or more lighting elements of the first lighting mechanism,
a second control for controlling a lighting property of the one or more lighting elements of the second lighting mechanism, and
a third control for controlling a lighting property of the one or more lighting elements of the third lighting mechanism.
